(19) United States
(12) Patent Application Publication
(10) Pub. No.: US 2008/0293013 A1
(43) Pub. Date: Nov. 27, 2008

(54) Try-in implant with snap fit assembly

(75) Inventors: Jost Lussi, Zurich (CH); Marc Zettler, Lorrach (DE)

Correspondence Address: RISSMAN JOBSE HENDRICKS & OLIVERIO, LLP, 100 Cambridge Street, Suite 2101, BOSTON, MA, 02114, US

(73) Assignee: Straumann Holding AG, Basel (CH)

(21) Appl. No.: 12/154,114

(22) Filed: May 20, 2008

(30) Foreign Application Priority Data
May 21, 2007 (EP) EP 07010 034.2

(51) Int. Cl. A61C 8/00

(52) U.S. Cl. 433/173

(57) ABSTRACT

A try-in implant for verifying the position and angulation of a pilot hole. The try-in implant comprises a body portion to be received in the pilot hole, a neck portion formed above the body portion, and an attachment portion formed above the neck portion. The attachment portion comprises a crown-like cap, which is mounted on the attachment portion by a snap fit assembly.

### FIELD OF THE INVENTION

The present invention relates to a try-in implant for verifying the position and angulation of a pilot hole.

### BACKGROUND

When installing dental implants, the positioning of the implant is extremely important to obtain a good aesthetic and functional result. The positioning of the implant to a large extent determines the choice of prosthetic components. In order to provide guidance for the surgeon during the installation of an implant, various types of so-called surgical guide rails have traditionally been used. These guide rails are mainly produced under laboratory conditions and can be made in a number of different designs. As aids during the surgical intervention it is also possible to use so-called directional sensors.

U.S. Pat. No. 5,208,845 discloses a radiographic depth gauge for positioning dental implants in a jaw bone. The gauge is formed of a material, which is x-ray visible, and is an elongated member with distance markings. The gauge both shows the depth and angulation of the drill hole relative to other holes and existing dentition.

U.S. Pat. No. 5,842,859 discloses an indication device for marking and forming one or more attachment points for one or more fixtures, which can be fitted into a receiving hole in which it bears via a bearing part. At least one indicating part is interconnected with the protruding part and has a free end extending away from the existing hole, where a location of the new hole to be used as an attachment point is established at a position substantially adjacent to an exterior surface of the free end of the indicating part.

However, the devices known up to now have the disadvantage that the surgeon has no visual impression of the dental prosthesis after implantation.

### SUMMARY OF THE INVENTION

The present invention provides a try-in implant for indicating the position of a dental prosthesis and which is easy and safe to handle.

In one embodiment, the try-in implant comprises a body portion to be received in a pilot hole, a neck portion formed above said body portion, whereby said neck portion has a sufficient length to project through mucosal tissue above said pilot hole, and an attachment portion formed above said neck portion. The attachment portion includes a crown-like cap, which is mounted on the attachment portion by a snap fit assembly.

The try-in implant indicates the geometry of the implant's prosthetic portion together with the mounted crown. Due to the visual identity or similarity of the try-in implant and the tooth prosthesis, meaning the final implant and the mounted crown, the surgeon has during the surgical intervention a visual impression of the situation after implantation and restoration. A mounted crown can be a rudimentary minimal (a crown framework) or like the final crown (a final porcelain veneering crown of average/generic shape). This enables an easier decision regarding the implant to be selected. Possible implants are one-part implants or two-part implants, they may have a straight or angulated mounting part and the length and/or diameter of the implants to be selected may also be determined.

The facial-lingual and mesial-distal, corona-apical and apical-incisal position as well as the distance to adjacent teeth and implants can be verified with a try-in implant according to the present invention. Functional and aesthetic long-term results can be predicted due to the use of such a try-in implant.

As the crown-like cap of the present invention is a separate component, which is mounted on the attachment portion by a snap fit assembly, it is possible to mount different forms of crown-like caps on the attachment portion in order to determine the optimal shape of the crown.

In a further embodiment of the present invention the crown-like cap comprises a handle to ensure easy and safe handling of the try-in implant. The handle is preferable integrated on the top of the crown-like cap. The handle on the crown-like cap ensures that the try-in implant can easily be inserted in the pilot hole, which means the first receiving hole or drill hole, by hand or by tweezers without being lost in the patient's mouth, thereby ensuring a safe handling.

In a further embodiment of the present invention the crown-like cap has a partly or fully gripping surface to ensure that the try-in implant cannot slip away during the handling procedure in the patient's mouth.

In another preferred embodiment of the present invention the handle or the crown-like cap comprises an opening. This opening allows for the secure retaining of the try-in implant, especially inside the patient's mouth, to prevent aspiration of the try-in implant. A thread or floss may be inserted through the opening and held outside a patient's mouth. In addition, the thread or floss can be used to assist in removing the try-in implant.

Depending on the pilot hole it may be necessary to select an implant with a straight or an angled abutment. Due to the fact that the try-in implant may have a straight or angled attachment portion, the surgeon may have a visual impression of both implant types. Therefore, the selection of the optimal implant is easier.

Preferably, the try-in implants have the same diameters as the implants. That means that that the body portion of the try-in implant has a diameter from 1.0 to 8.0 mm, preferably consisting of the group of 2.2 mm, 2.8 mm, 3.0 mm, 3.5 mm, 4.2 mm, 5 mm and 5.5 mm. Especially preferred are those having a diameter from 2.0 to 3.0 mm, for example 2.2 mm and 2.8 mm.

In order to predict the optimal length of the implant, the body of try-in implant may have different lengths, preferably a length of 6 mm to 8 mm. It is also possible that the try-in implants include a height indicator, designed with horizontal or lacuna markings. Such a height indicator makes it possible to decide whether an adjustment of the pilot hole is necessary, and which implant length should be selected.

Preferably the try-in implants have depending on their diameter and size, a specific color, which serves as a color code. Alternatively they have a tooth-like colour to support the visual impression.

In one embodiment of the present invention the try-in implant comprises mainly a metal selected from the group consisting of titanium, zirconium, and stainless steel; preferably the try-in implant is titanium or stainless steel. Alternatively the implants comprise an alloy of metals selected from the group consisting of cobalt, chromium, titanium, zirconium, niobium, hafnium and tantalum. Most preferred are 316 stainless steel, Ti6Al4V, Ti6Al7Nb and a Cr—Co alloy.

In another embodiment of the present invention the try-in implant is made of a synthetic material. The synthetic material is selected from the group consisting of ceramic, such as aluminum oxide or zirconium oxide, composite materials, as well as polymers, especially biocompatible USP Class 6 compliant polymers, such as PEEK (polyetheretherketone), POM (polyoxymethylene), Grilamid TR 70 LX of EMS, PEI of Sulzer Medica (polyethylene imine), PTFE (polytetrafluorethylene), PP (polypropylene), PMP (polymethylpentene), PPSU (polyphenylsulfone), PE (polyethylene), and PC (polycarbonate). Preferably the implant is made of PEEK or POM.

Typically, a series of x-rays are taken in order to determine where and how to position the implants in the jaw bone without damaging surrounding structures such as the nerves in the lower jaw bone and the sinuses adjacent the upper jaw bone. Based on said x-ray the pilot hole is drilled in the jaw bone. If, according to a further embodiment of the present invention, the try-in implant is made of a metal or synthetic material, which is X-ray visible, a further x-ray can be taken to determine the angulation of the pilot hole relative to existing dentition and the depth of the pilot hole relative to anatomical restriction. A possible synthetic material, which is X-ray visible, is BaSO₄ containing PEEK or ZrO₂ itself. X-ray visibility of the try-implant permits optimal selection of the implant (one-part vs. two-part, straight or angled abutment as well as length of the implant) as well as the precision placement of implants to their maximum depth in the jaw bone to assure a maximum strength for supporting one or more dental restorations.

In one embodiment of the present invention the try-in implants can be sterilized and therefore be used several times. Alternatively, it is possible to produce the try-in implants made of a synthetic material as a single-use product guaranteeing a sterile product; this may be highly desired by consumers due to infection risks such as HIV or hepatitis.

### BRIEF DESCRIPTION OF THE DRAWINGS

The invention is explained below on the basis of figures and illustrative embodiments, without in any way limiting the invention to the embodiments shown. The drawings show the following:

FIG. 1 an implant with a crown;

FIG. 2 a side view of a first embodiment of a try-in implant according to the invention;

FIG. 3 a side view of an embodiment of a try-in implant according to the invention, wherein the attachment portion comprises a crown-like cap;

FIG. 4 a side view of a further embodiment of a try-in implant according to the invention, wherein the crown-like cap has a partly or fully gripping surface;

FIG. 5 a side view of a further embodiment of a try-in implant according to the invention, wherein the crown-like cap is mounted on the attachment portion by a snap fit assembly;

FIG. 6 a side view of a further embodiment of a try-in implant according to the present invention, wherein a handle is mounted on top of the crown-like cap; and

FIG. 7 a side view of a further embodiment of a try-in implant according to the invention with an opening to prevent aspiration of the try-in implant.

### DETAILED DESCRIPTION

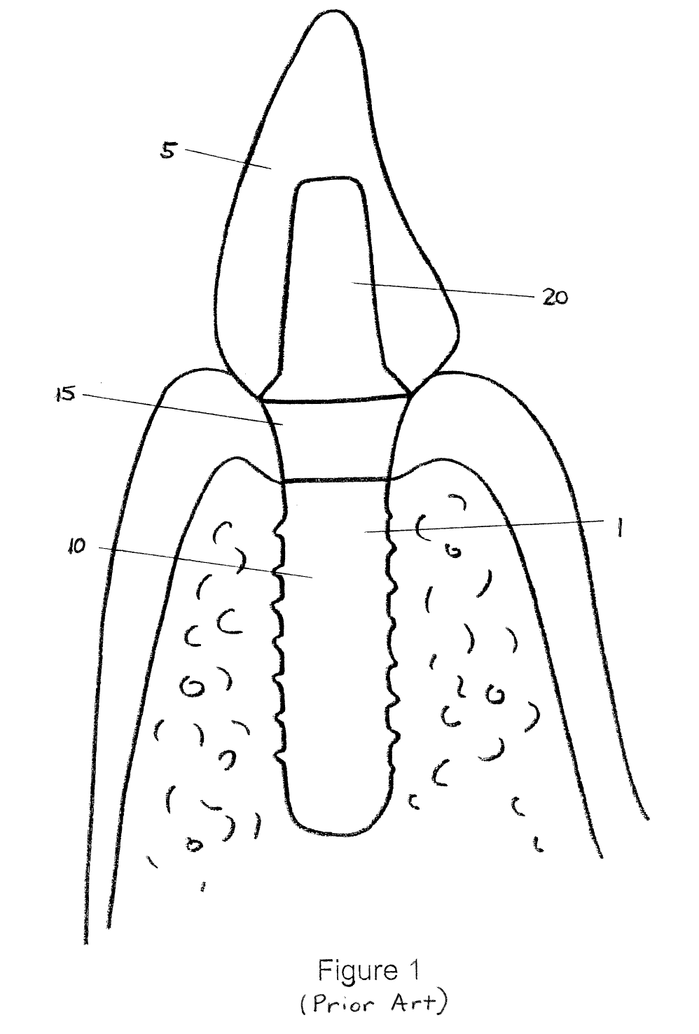

FIG. 1 shows a final implant 1 with a mounted crown 5 according to the state of the art. It comprises an anchoring part 10 with a threaded section, a neck part 15 and a mounting part 20. On the mounting part 20 the crown 5 is attached.

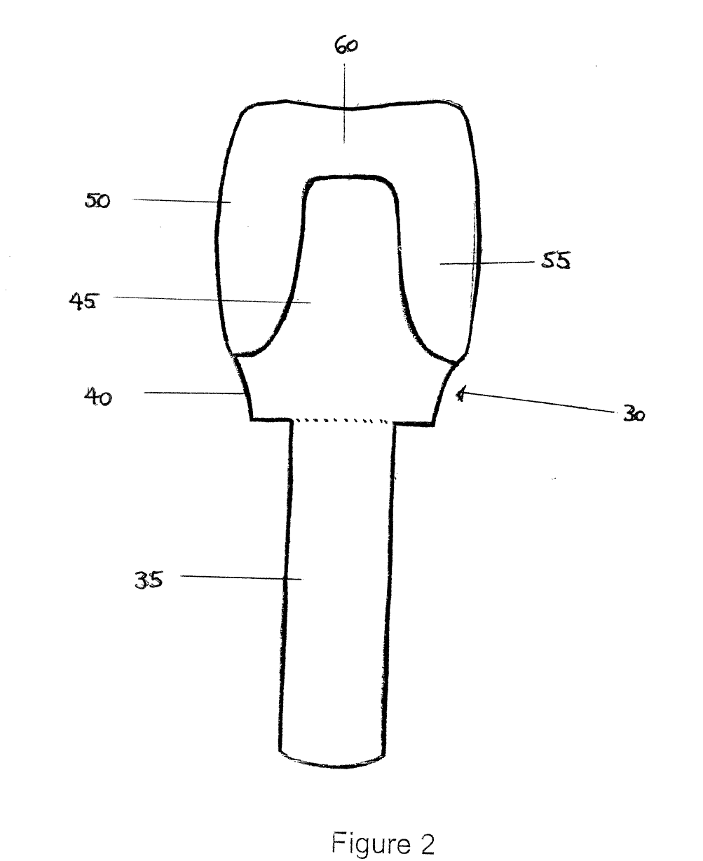

FIG. 2 shows a try-in implant 30 according to one embodiment of the present invention. The try-in implant 30 comprises a body portion 35 to be received in a pilot hole. The body portion 35 corresponds to the anchoring part 10 with a threaded section of the final implant. At the upper end of the body portion 35 a neck portion 40 is formed which may comprise a slightly enlarged conical section, with a sufficient length to project through mucosal tissue above the pilot hole. Above said neck portion 40 an attachment portion 45 is formed, which corresponds to the mounting part 20 of the final implant. The attachment portion 45 includes a crown-like cap 50, resulting in a visual impression, which corresponds to the situation after the implantation and restoration. The crown-like cap 50 may have various forms corresponding to the different teeth, that is, the form of a premolar crown, incisor crown, rudimentary framework, generic shape etc. In FIG. 2 a premolar crown-like cap is shown. According to the embodiment of the present invention shown in FIG. 2 the crown-like cap is a separate component of the try-in implant. That means that it can be attached on the attachment portion 45 before inserting the try-in implant in the pilot hole. Depending on the situation in the patient's mouth the surgeon may select from crown-like caps 50 with different wall thicknesses, whereby said wall thickness may depend on a minimal framework versus complete crown and on a material of the crown (metal or ceramic). The wall thickness on the side 55 of the crown-like cap 50 varies from 0.3 mm to 2 mm and the wall thickness on the top 60 of the crown-like cap 50 varies from 0.8 mm to 6 mm. The try-in implant 30 is made of a biocompatible metal or synthetic material as mentioned above. Preferably it is made of PEEK or POM.

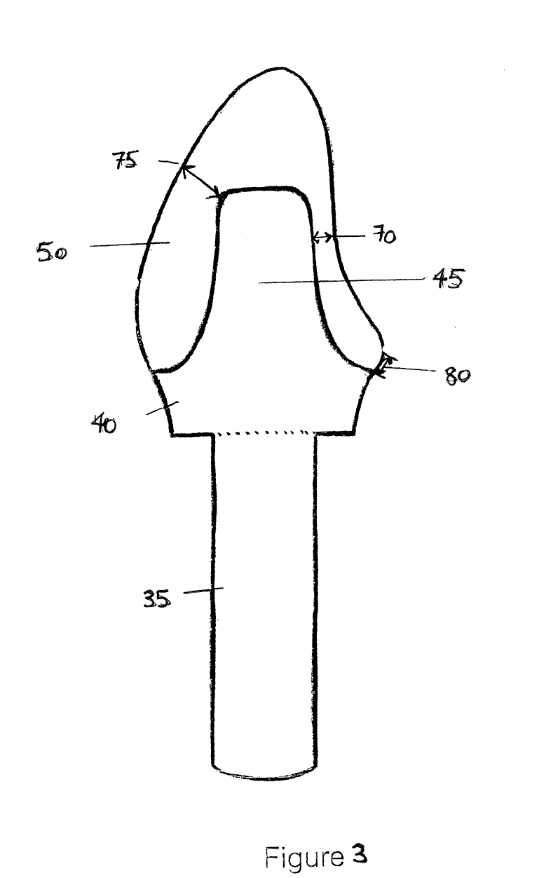

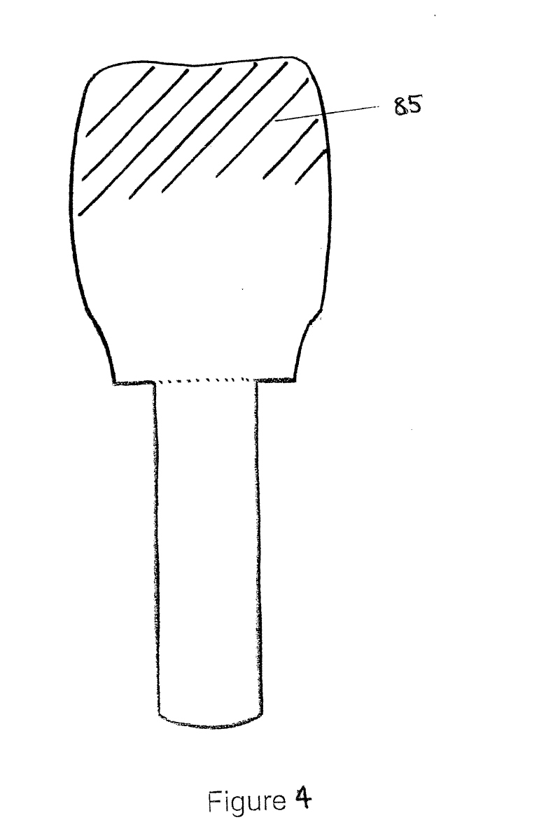

FIG. 3 shows a try-in implant with an incisor crown-like cap 50. Similar to the embodiment shown in FIG. 2 the surgeon may select from crown-like cap 50 with different wall thicknesses, whereby the wall thickness on the side 70 of the crown-like cap 50 varies from 0.3 mm to 2 mm, the wall thickness 75 of the crown-like cap 50 varies from 0.5 mm to 2 mm and the wall thickness at the bottom 80 of the crown-like cap 50 varies from 0.05 to 0.5 mm. FIG. 4 shows a further preferred embodiment of the present invention, wherein the crown-like cap 50 has a partly gripping surface 85. Alternatively, the crown-like cap may include a cavity, which allows a better gripping for example by tweezers. Such a try-in implant can be easily inserted in the pilot hole by hand or by tweezers without being lost in the patient's mouth, thereby ensuring a safe handling.

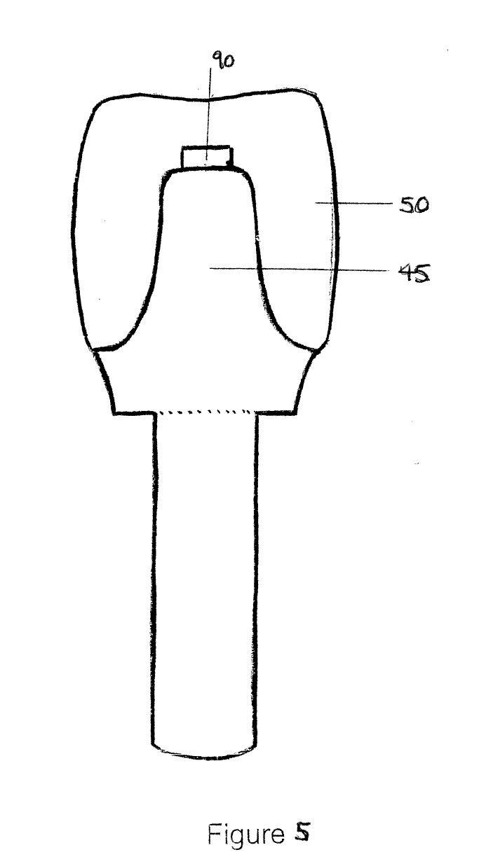

FIG. 5 shows a further embodiment of the present invention, wherein the crown-like cap 50 is a separate component. Said crown-like cap 50 is attached on the attachment portion by a snap-fit assembly 90 which ensures that the crown-like cap does not shift away in the patient's mouth.

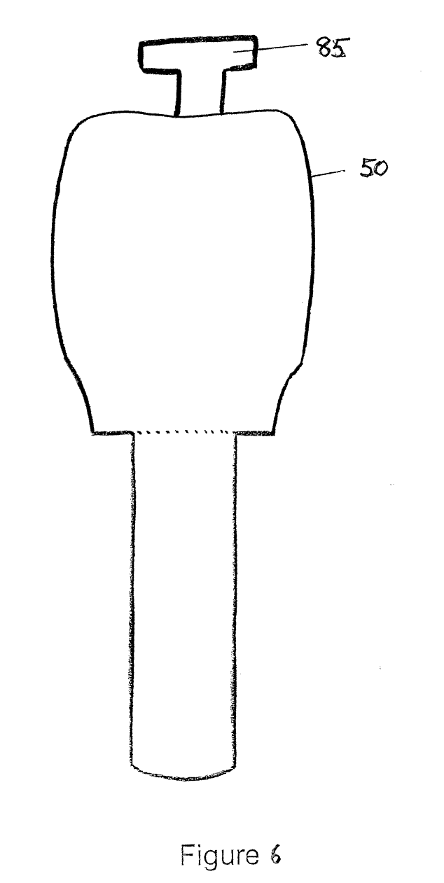

FIG. 6 shows a further embodiment of the present invention, wherein a handle 85 is attached on the crown-like cap 50. The handle 85 may have various forms, which can easily be gripped by hand or by tweezers, such as T-shape, triangular, rectangular, squarish, circular or semicircular. Preferably the handle 85 has a gripping surface. Alternatively the handle 85 may be integrated.

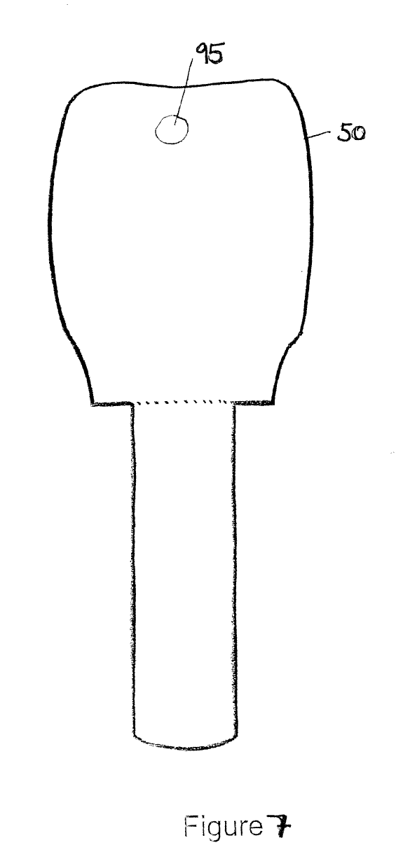

FIG. 7 shows a try-in implant 30, wherein the crown-like cap 50 includes an opening 95. This opening allows for the secure retaining of the try-in implant, especially inside the patient's mouth, to prevent aspiration of the try-in implant. A thread or floss, may be inserted through the opening 95 and held outside the patient's mouth. Additionally, the thread or floss may be used to assist in removing the try-in implant in a safe and quick way. As an alternative a handle as shown in FIGS. 4 and 6 may comprise an opening for the prevention of aspiration of the try-in implant.

1. Try-in implant for verifying a position and angulation of a pilot hole, said try-in implant comprising
a body portion to be received in said pilot hole, a neck portion formed above said body portion, and an attachment portion formed above said neck portion, the attachment portion including a crown-like cap, wherein the crown-like cap is mounted on the attachment portion by a snap fit assembly.

2. Try-in implant according to claim 1, wherein the crown-like cap includes a handle.

3. Try-in implant according to claim 1, wherein the crown-like cap has a partly or fully gripping surface.

4. Try-in implant according to claim 2, wherein the handle comprises an opening for secure retaining of the try-in implant to prevent aspiration of the try-in implant.

5. Try-in implant according to claim 1, wherein the crown-like cap includes an opening for the secure retaining of the try-in implant to prevent aspiration of the try-in implant.

6. Try-in implant according to claim 1, wherein the attachment portion is straight or angulated.

7. Try-in implant according to claim 1, wherein the body portion has a length of 6 to 8 mm.

8. Try-in implant according to claim 1, wherein the body portion includes height indicators.

9. Try-in implant according to claim 1, wherein the body portion has a diameter from 1 to 8 mm.

10. Try-in implant according to claim 1, wherein the implant is made of metal or a synthetic material.

11. Try-in implant according to claim 10, wherein the implant is made of a synthetic material selected from the group consisting of ceramic, composite materials and polymers.

12. Try-in implant (30) according to claim 11, characterized in that the implant is made of PEEK or POM.

13. Try-in implant according to claim 11, wherein the synthetic material is X-ray visible.

14. Try-in implant according to claim 1, wherein the try-in implant can be sterilized.

15. Try-in implant according to claim 1, wherein the try-in implant is a single use try-in implant.

16. Try-in implant of claim 11, wherein the synethetic material is one or more polymers selected from the group consisting of PEEK, POM, Grilamid TR 70 LX, PEI, PTFE, PP, PMP, PPSU, PE and PC.
